(19) United States
(12) Patent Application Publication
(10) Pub. No.: US 2008/0000733 A1
(43) Pub. Date: Jan. 3, 2008

(54) SPRING BRAKE INTERNAL VENTING

(76) Inventor: Rodney P. Ehrlich, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/533,917

(22) Filed: Sep. 21, 2006

Related U.S. Application Data
(60) Provisional application No. 60/813,413, filed on Jun. 14, 2006.

(51) Int. Cl. F16D 51/00

(52) U.S. Cl. 188/79.55

(57) ABSTRACT

A brake actuator redirects pressurized air that compressed a parking brake spring to the other side of a piston upon release of the parking brake spring. The redirected air is clean air which removes contaminates and pushes them out a one-way check exhaust. A first embodiment of the brake actuator uses an external quick release valve to take exhaust air from a pressure chamber and direct it to the spring chamber. A second embodiment of the brake actuator uses the spring brake control valve to take exhaust air from the pressure chamber and direct it to the spring chamber. In each embodiment, the pressurized air pushes out the excess air past the one-way check exhaust, carrying all contaminates with it. The brake actuator can also advantageously be operated under water without the water entering the spring chamber.

### CROSS-REFERENCE AND INCORPORATION BY REFERENCE

This patent application claims the benefit of domestic priority of U.S. Provisional Application Ser. No. 60/813,413, filed Jun. 14, 2006, and entitled “Spring Brake Internal Venting”. U.S. Provisional Application Ser. No. 60/813,413 is hereby incorporated by reference in its entirety.

### FIELD OF THE INVENTION

The present invention relates to a novel parking brake actuator used in the trucking industry.

### BACKGROUND OF THE INVENTION

For the last seventy-five (75) years, the heavy truck industry has used a pneumatic actuator to create the force necessary to apply a service brake of a truck, e.g, for normal braking during driving operations. Parking brakes for the trucks were originally actuated by applying full system air pressure to the parking brake actuator when the truck was being parked. Such a parking brake configuration had its drawbacks because if an air leak was present, the parking brake pressure slowly decayed, thus releasing the parking brake over time.

This very undesirable characteristic was corrected in 1975 when the National Highway Traffic Safety Administration (NHTSA) enacted a rule that required a mechanical actuated parking brake as opposed to air pressure. In response, many truck manufacturers incorporated spring actuated parking brakes that had a powerful spring contained in a separate parking brake assembly that was stacked in tandem on the back of the service brake assembly. These types of spring actuated parking brakes were offered as a safety option to improve parking and emergency braking performance prior to the 1975 law. With a spring actuated parking brake, air pressure was used to compress the spring to release the parking brake as opposed to applying the service brake.

Early spring parking brake assemblies were of a piston and cylinder design which had disadvantages. If the spring chamber was vented to the atmosphere to prevent pressurization during compression of the spring, moisture could enter the vented chamber and freeze on the wall of the cylinder causing damage to the piston or even locking up the piston. To overcome this disadvantage, an internal venting system was designed and incorporated into such a spring parking brake assembly, as illustrated in FIG. 1.

FIG. 1 illustrates a brake actuator 20 including a service brake assembly 22 and a separate parking brake assembly 24 stacked in tandem on the back of the service brake assembly 22. The configuration and operation of the service brake assembly 22 is well-known by one of ordinary skill in the art and, therefore, the structure and function of the service brake assembly 22 will not be discussed in detail herein unless otherwise noted.

The parking brake assembly 24 includes a piston 26 movable within a cylinder 28. The piston 26 is secured to a push rod 30 which extends into a service brake pressure chamber 23 of the service brake assembly 22. The push rod 30 is movable through a sealing element 32 which securely seals off the service brake pressure chamber 23 from a parking brake pressure chamber 34, regardless of whether the parking brake is applied. The piston 26 generally separates the cylinder 28 into the pressure chamber 34 and a spring chamber 36. A spring 38 is positioned within the spring chamber 36 and acts against the piston 26. The parking brake assembly 24 has an inlet 40 into which pressurized air is introduced into the pressure chamber 34. The inlet 40 is normally sealed by a one-way valve 42.

When the parking brake is not applied, pressurized air is introduced through the inlet 40 (as illustrated by the arrows), causing the one-way valve 42 to unseal from the inlet 40 and to seat against an opening 43 to the spring chamber 36, see FIG. 1. This causes the pressurized air to flow into the pressure chamber 34 and causes the piston 26 to act against, and overcome the spring force of, the spring 38 in the spring chamber 36, in order to compress the spring 38. This compression causes the spring 38 to be captured, preventing the push rod 30 from moving into the service brake pressure chamber 23, as illustrated in FIG. 1.

When it is desired to apply the parking brake, the supply of pressurized air through the inlet 40 is stopped (not illustrated), such that the one-way valve 42 reseals onto the inlet 40 and the opening 43 is unobstructed. The pressurized air within the pressure chamber 34 flows into the spring chamber 36 through the opening 43, around the spring 38 and out of the spring chamber 36 via a one-way check exhaust 44. The pressurized air is generally blasted out of the one-way check exhaust 44, thus likely removing any contamination within the brake actuator 20. Because the air pressure is not sufficient to keep the spring 38 compressed, the spring 38 expands. This causes the piston 26 to move in the cylinder 28, thereby moving the push rod 30 through the sealing element 32 to push against a diaphragm 46 within the service brake pressure chamber 23, and thus against a piston 48 within the service brake pressure chamber 23, in order to compress a spring 50 within the service brake pressure chamber 23. This action causes a braking arm 52, which is secured to the piston 48, to be held in a position which applies the brake in a manner known in the art.

This design worked very well, but was very expensive to manufacture and could be easily damaged by denting the wall of the cylinder 28. As such, an alternative, more cost effective design was sought to replace the piston and cylinder parking brake assembly 24.

The solution was to provide a brake actuator 20a having a parking brake assembly 24a provided in tandem on the back end of the service brake assembly 22a (generally identical to the service brake assembly 22 of the brake actuator 20) which used a rubber diaphragm 54a, similar to the rubber diaphragm 46 used in the service brake assembly 22 in FIG. 1, in order to seal the air around a loose fitted piston 26a. External venting in the parking brake spring chamber 36a was made simple by placing several vent holes 56a in the wall of the parking brake assembly 24a. This design is more economically efficient than the piston and cylinder parking brake assembly 24 and, therefore, this design became the standard used in the industry for the last thirty (30) years. This design is commonly referred to in the industry as a double diaphragm spring brake actuator, and is illustrated in FIGS. 2-4.

Operation of the double diaphragm spring brake actuator 20a is illustrated in FIGS. 2-4. The spring brake actuator 20a is a double functioning pneumatic powering unit. The spring brake actuator 20a uses compressed air to apply a force for operating the brake through the braking arm 52a. As with the parking brake assembly 24, illustrated in FIG. 1, the parking brake assembly 24a works in essentially the opposite manner as does the service brake assembly 22a in that the parking brake assembly 24a uses compressed air to overcome the output force of the parking brake spring 38a to release the parking brake. The spring brake actuator 20a can therefore apply the parking brake when all air pressure is lost in the system, which is the emergency back-up function.

FIG. 2 illustrates the spring brake actuator 20a in a fully released mode where neither the service brake or the parking brake is applied. The parking brake spring 38a has been compressed by pressurized air in the pressure chamber 34a, introduced therein via the inlet 40a, pushing on the diaphragm 54a and thus the piston 26a (as illustrated by the arrows in the pressure chamber 34a). There is no pressurized air in the service brake pressure chamber 23a, and therefore, the piston 48a is positioned against the push rod 30a because of the spring force of the spring 50a in the service brake assembly 22a. With the piston 48a in this retracted position, the braking arm 52a which extends therefrom is also retracted (as shown by the arrow directed to the right in FIG. 2) such that the brake is not applied.

FIG. 3 illustrates the spring brake actuator 20a in a position where the service brake is applied, but the parking brake is not applied. In this mode, the parking brake spring 38a is out of the way and the push rod 30a is retracted, as shown and described with regard to FIG. 2, but pressurized air has been delivered to the service brake pressure chamber 23a between the diaphragm 46a and the end of the push rod 30a by known means (as illustrated by the arrows in the service brake pressure chamber 23a). The pressurized air pushes the diaphragm 46a and thus the piston 48a toward the service brake spring 50a to compress the service brake spring 50a. Compression of the service brake spring 50a by movement of the piston 48a causes the braking arm 52a to be extended in order to apply the service brake (as shown by the arrow directed to the left in FIG. 3).

FIG. 4 illustrates the spring brake actuator 20a in a position where the parking brake is applied. In this mode, the air in the service brake pressure chamber 23a has been exhausted by known means and the compressed air in the pressure chamber 34a is returned to a spring brake control valve (not shown)—which supplies the pressurized air to the pressure chamber 34a—via the inlet 40a (as shown by the arrows extending from the pressure chamber 34a and out of the inlet 40a) and exhausted out of the spring brake control valve via an exhaust port (not shown) provided therein. As a result, the spring 38a is expanded to move the piston 26a, which in turn moves the push rod 30a (as shown by the arrow directed to the left on the push rod 30a in FIG. 4) to cause the end to move into the service brake pressure chamber 23a, against the diaphragm 46a and thus the piston 48a. The piston 48a causes the spring 50a to contract and causes the braking arm 52a to be extended, or stay extended, if the service brake had previously been applied, in order to apply the parking brake (as shown by the arrow directed to the left in FIG. 4).

In each of these positions, atmospheric air is allowed to flow in and out of the spring chamber 36a via the vent holes 56a provided in the wall of the parking brake spring chamber 36a as necessary.

The design of the parking brake assembly 24a, however, while solving the problems of the parking brake assembly 24 as discussed hereinabove with regard to FIG. 1, has a number of other problems associated therewith. Most specifically, the parking brake assembly 24a, because of the vent holes 56a in the wall of the parking brake spring chamber 36a, allows contaminated air to enter the parking brake assembly 24a which causes corrosion of the main spring 38a and housing in the parking brake assembly 24a. The powerful spring 38a is subject to early failure when it has been attacked by corrosion. Various coatings have been used to try and improve the corrosion resistance of the spring 38a, but to date nothing has been successful as each of the coatings will eventually wear off and allow the contaminated air to directly contact the spring 38a. Other venting and filtering systems have been tried to correct this problem, but none have been totally successful.

Thus, there is a need for a brake actuator having a parking brake assembly for applying a parking brake which conforms to the 1975 law enacted by the NHTSA, is economical to manufacture, but which also prevents corrosion of the spring in the parking brake assembly caused by contaminants allowed to enter the parking brake assembly.

### SUMMARY OF THE INVENTION

A brake actuator redirects pressurized air that compressed a parking brake spring to the other side of a piston upon release of the parking brake spring. The redirected air is clean air which removes contaminates and pushes them out a one-way check exhaust. A first embodiment of the brake actuator uses an external quick release valve to take exhaust air from a pressure chamber and direct it to the spring chamber. A second embodiment of the brake actuator uses the spring brake control valve to take exhaust air from the pressure chamber and direct it to the spring chamber. In each embodiment, the pressurized air pushes out the excess air past the one-way check exhaust, carrying all contaminates with it. The brake actuator can also advantageously be operated under water without the water entering the spring chamber.

### BRIEF DESCRIPTION OF THE DRAWINGS

The features of the invention which are believed to be novel are described in detail hereinbelow. The organization and manner of the structure and operation of the invention, together with further objects and advantages thereof, may best be understood by reference to the following description taken in connection with the accompanying drawings wherein like reference numerals identify like elements in which:

FIG. 1 illustrates a partial cross-sectional view of a prior art brake actuator including a parking brake assembly having a piston and cylinder design;

FIGS. 2-4 illustrate partial cross-sectional views of a prior art double diaphragm spring brake actuator;

FIGS. 5-8 illustrate a first embodiment of a spring brake actuator which incorporates features of the present invention having an external quick release valve; and

FIGS. 9-12 illustrate a second embodiment of a spring brake actuator which incorporates features of the present invention having a spring brake control valve.

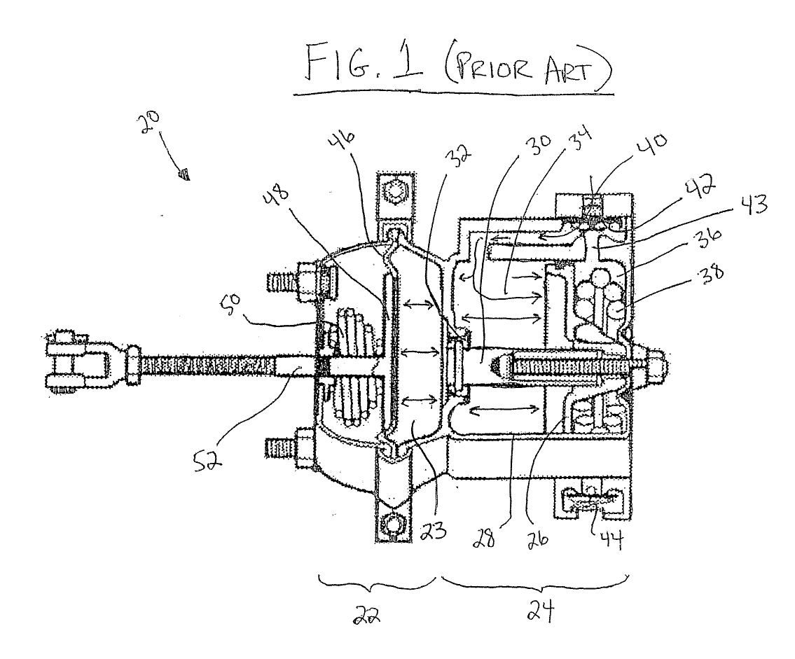

### DETAILED DESCRIPTION OF THE ILLUSTRATED EMBODIMENTS

While this invention may be susceptible to embodiment in different forms, there is shown in the drawings and will be described herein in detail, specific embodiments with the understanding that the present disclosure is to be considered an exemplification of the principles of the invention, and is not intended to limit the invention to that as illustrated.

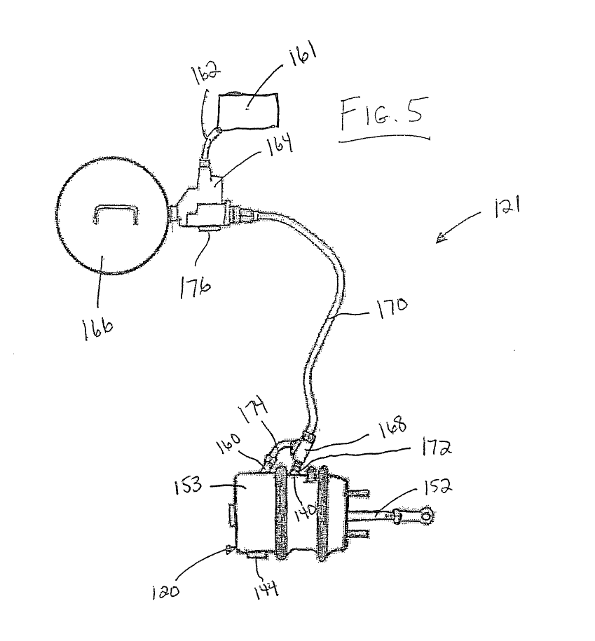

A first embodiment of a brake actuator 120 and a brake assembly 121 in which the brake actuator 120 is incorporated within is illustrated in FIGS. 5-8. A second embodiment of a brake actuator 220 and a brake assembly 221 in which the brake actuator 220 is incorporated within is illustrated in FIGS. 9-12. Like elements are denoted with like reference numerals with the first embodiment of the brake actuator 120 and the brake assembly 121 being in the one hundreds, and the second embodiment of the brake actuator 220 and the brake assembly 221 being in the two hundreds. Each of these brake actuators 120, 220 and brake assemblies 121, 221 overcome the problems of the prior art by redirecting the pressurized air that compressed the parking spring to the other side of the diaphragm and piston upon release of the parking spring. This redirected clean air removes contaminates, if any, and pushes them out a one-way spring loaded check valve. Venting is no longer done by allowing outside contaminated air to come into the parking brake assembly. The air used comes from a compressor system that has been dried and filtered.

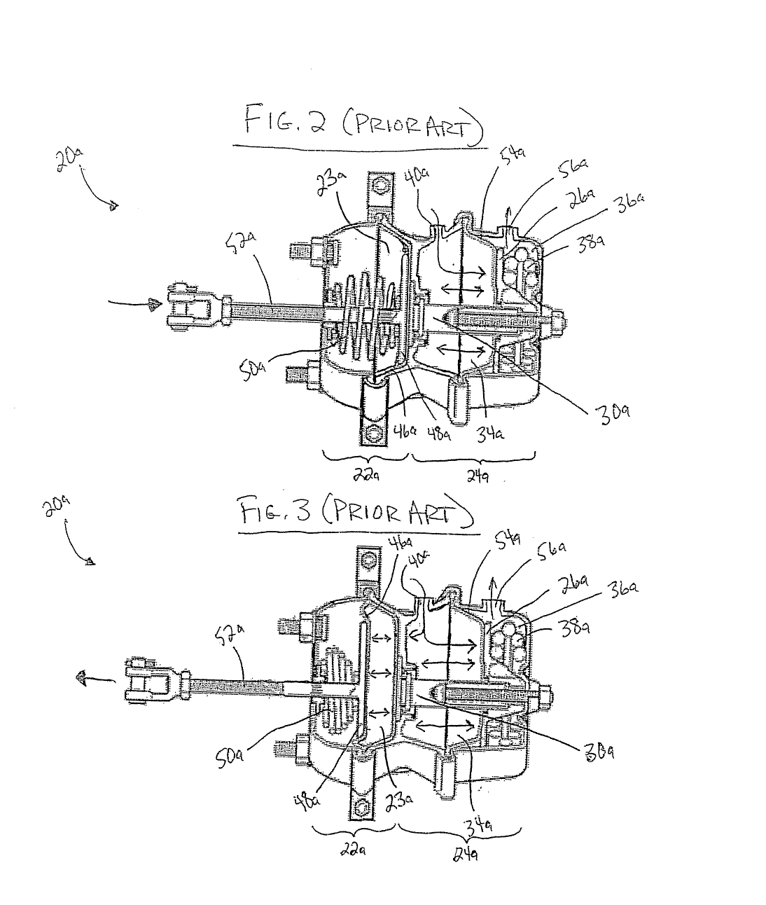

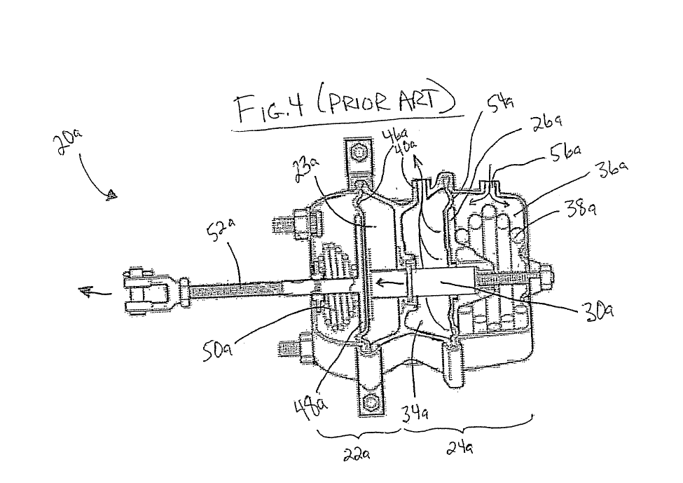

The brake actuators 120, 220 are identical to one another and, therefore, will be described together. The brake actuators 120, 220 are very similar to the brake actuator 20a described and illustrated in FIGS. 2-4, but have been modified to overcome the problems associated with the brake actuator 20a.

The brake actuators 120, 220 have a parking brake assembly 124, 224 provided in tandem on the back end of a service brake assembly 122, 222. The service brake assembly 122, 222 is identical to the service brake assembly 22a described and illustrated in FIGS. 2-4 and, therefore, will not be repeated herein for brevity purposes.

The parking brake assembly 124, 224 has a housing 153, 253 which has a diaphragm 154, 254 therein, which is preferably formed of an elastomeric material, such as rubber, which separates the housing 153, 253 of the parking brake assembly 124, 224 into a pressure chamber 134, 234 and a spring chamber 136, 236. The diaphragm 154, 254 seals off the pressure chamber 134, 234 from the spring chamber 136, 236. A spring 138, 238 is positioned within the spring chamber 136, 236 and acts against a piston 126, 226, which is preferably loose-fitted, which is also positioned within the spring chamber 136, 236. The piston 126, 226 acts against the diaphragm 154, 254 and is secured to a push rod 130, 230. The push rod 130, 230 extends into a service brake pressure chamber 123, 223 of the service brake assembly 122, 222 and is movable through a sealing element 132, 232 which securely seals off the service brake pressure chamber 123, 223 from the parking brake pressure chamber 134, 234, regardless of whether the parking brake is applied.

A first inlet 140, 240 is provided through the housing 153, 253 which is in communication with the pressure chamber 134, 234 and a second inlet 160, 260 is provided through the housing 153, 253 which is in communication with the spring chamber 136, 236. The second inlet 160, 260 is provided in place of the vent holes 56a provided in the brake actuator 20a described and illustrated in FIGS. 2-4. A one-way check exhaust 144, 244 is provided through the housing 153, 253 which is in communication with the spring chamber 136, 236. The one-way check exhaust 144, 244 may be provided opposite the second inlet 160, 260.

Attention is directed to FIGS. 5-8 and the brake assembly 121 utilized in connection with the brake actuator 120. The brake assembly 121 includes the brake actuator 120, an air source 161, an air supply line 162, a spring brake control valve 164, a reservoir 166, a quick release valve 168 and first, second and third air delivery lines 170, 172, 174. The spring brake control valve 164 is of a type well-known in the art and may include an exhaust port 176. Separate ports, other than the exhaust port 176, on the spring brake control valve 164 connect the spring brake control valve 164 to the air supply line 162, the reservoir 166 and the first air delivery line 170. The air supply line 162 is connected to the air source 161 and a compressor system (not shown) which provide dried and filtered air to the air supply line 162, which in turn supplies same to the reservoir 166. The first air delivery line 170 extends from the spring brake control valve 164 to the quick release valve 168. The second air delivery line 172 extends from the quick release valve 168 to the first inlet 140 of the brake actuator 120. The third air delivery line 174 extends from the quick release valve 168 to the second inlet 160 of the brake actuator 120.

Operation of the brake actuator 120 and the brake assembly 121 will now be discussed with reference to FIGS. 5-8. FIG. 6 illustrates the spring brake actuator 120 in a fully released mode where neither the service brake or the parking brake is applied. When the parking brake is released, the pressurized air is directed from the reservoir 166 through the first air delivery line 170, into the quick release valve 168 and into the second air delivery line 172. The quick release valve 168 is configured at this stage to prevent the pressurized air from moving into the third air delivery line 174. The pressurized air in the second air delivery line 172 flows into the pressure chamber 134 via the inlet 140 and pushes on the diaphragm 154 and thus the piston 126 (as illustrated by the arrows in the second air delivery line 172, the inlet 140 and the pressure chamber 134). The piston 126 thus compresses the spring 138. There is no pressurized air in the service brake pressure chamber 123 (it should be noted that separate components of the brake assembly 121 supply air to the service brake pressure chamber 123 but these components are not described or illustrated as they are well-known in the art and are not considered germane to the present invention), and therefore, the piston 148 is positioned against the diaphragm 146 which, in turn, is positioned against the push rod 130 because of the spring force of the spring 150 in the service brake assembly 122. With the piston 148 in this retracted position, the braking arm 152 which extends therefrom is also retracted (as shown by the arrow directed to the right in FIG. 6) such that the brake is not applied.

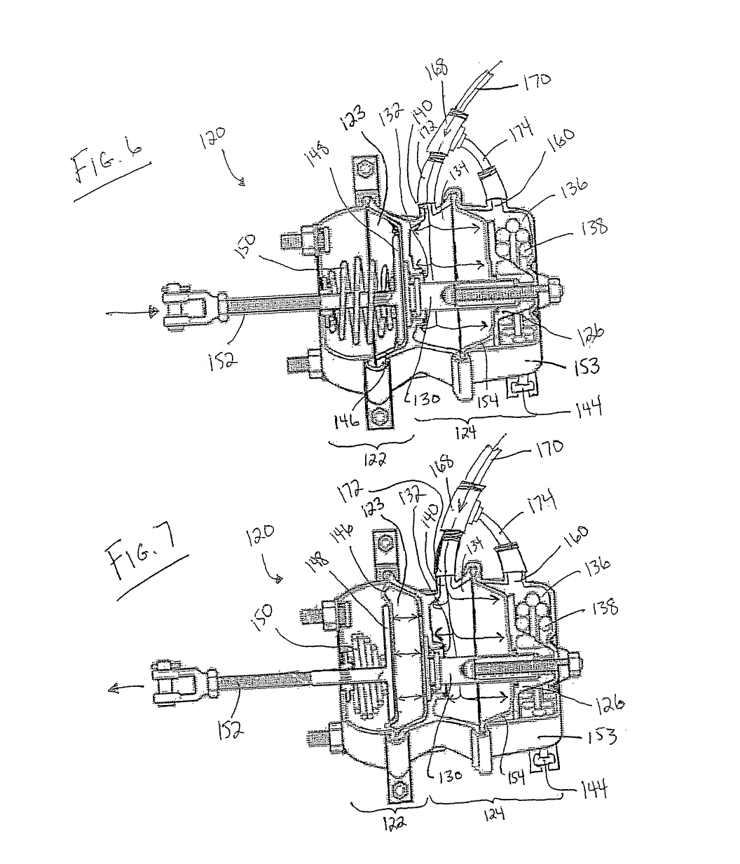

FIG. 7 illustrates the spring brake actuator 120 in a position where the service brake is applied, but the parking brake is not applied. In this mode, the parking brake spring 138 is out of the way and the push rod 130 is retracted, as shown and described with regard to FIG. 6, but pressurized air has been delivered to the service brake pressure chamber 123 between the diaphragm 146 and the end of the push rod 130 (as illustrated by the arrows in the service brake chamber 122) by known means. The pressurized air pushes the diaphragm 146 and thus the piston 148 toward the service brake spring 150 to compress the service brake spring 150. Compression of the service brake spring 150 by movement of the piston 148 causes the braking arm 152 to be extended in order to apply the service brake (as shown by the arrow directed to the left in FIG. 7).

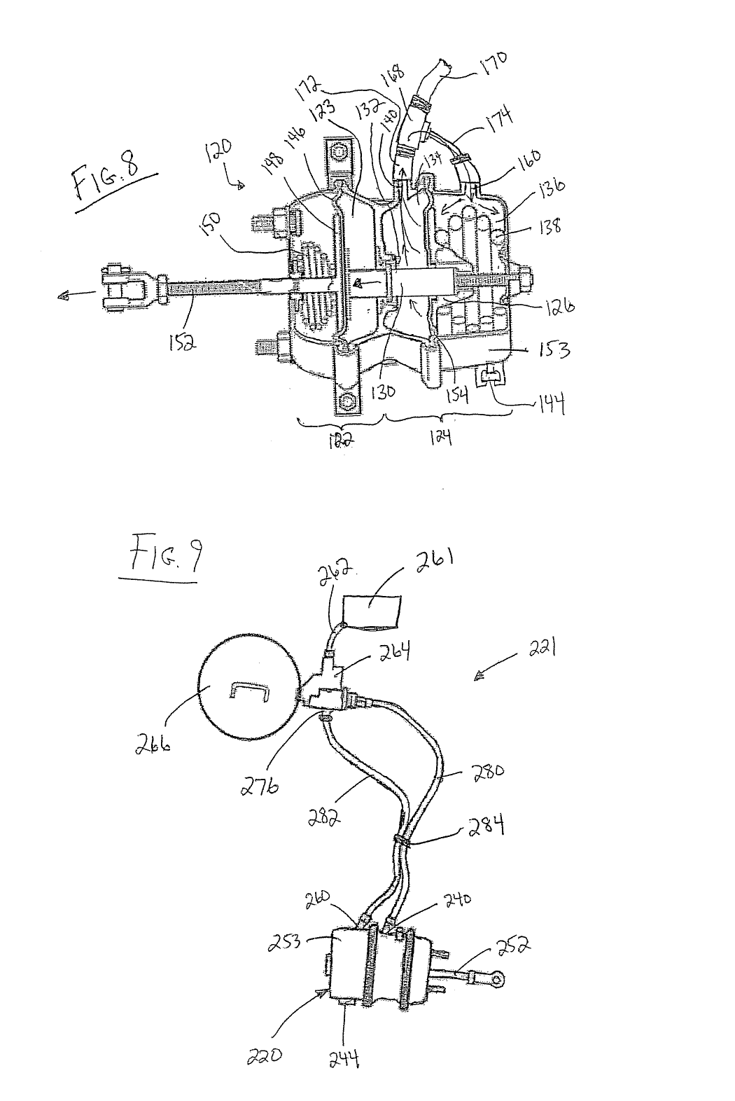

FIG. 8 illustrates the spring brake actuator 120 in a position where the parking brake is applied. In this mode, the air in the service brake pressure chamber 123 may have been exhausted by known means and the spring brake control valve 164 has stopped the supply of air to the first air delivery line 170. The quick release valve 168 is configured at this stage to prevent the pressurized air from moving into the first air delivery line 170 and back to the spring brake control valve 164. Rather, the quick release valve 168 is configured to allow the pressurized air to flow from the pressure chamber 134, into the second delivery line 172, through the quick release valve 168, into the third delivery line 174, into the second inlet 160 and into the spring chamber 136 (as shown by the arrows).

As a result of the pressurized air moving out of the pressure chamber 134, the spring 138 expands to move the piston 126, which in turn moves the push rod 130 (as shown by the arrow directed to the left on the push rod 130 in FIG. 8) to cause the end thereof to move into the service brake pressure chamber 123, against the diaphragm 146 and thus the piston 148. The piston 148 causes the spring 150 to compress and causes the braking arm 152 to extend, or to stay extended, if the service brake had previously been applied, in order to apply the parking brake (as shown by the arrow directed to the left in FIG. 8).

As a result of the pressurized air from the pressure chamber 134 being rerouted or redirected into the spring chamber 136 via the quick release valve 168 and the second and third air delivery lines 172, 174, the pressurized air flows into the spring chamber 136 and any excess pressurized air exits the brake actuator 120 via the one-way check exhaust 144. The redirected pressurized air causes a purging action in the event contaminates get inside the spring chamber 136 from any means. As the pressurized air pressurizes the spring chamber 136, excess air is pushed out via the one-way check exhaust 144, carrying with it any contamination. In addition, the pressurized air being rerouted or redirected from the pressure chamber 134 into the spring chamber 136 provides a pressure assist to cause the spring 138 to expand more rapidly such that the parking brake will be applied more quickly.

Attention is directed to FIGS. 9-12 and the brake assembly 221 utilized in connection with the brake actuator 220. The brake assembly 221 includes the brake actuator 220, an air source 261, an air supply line 262, a spring brake control valve 264, a reservoir 266, and first and second air delivery lines 280, 282. The spring brake control valve 264 is of a type well-known in the art and includes an exhaust port 276. Separate ports, other than the exhaust port 276, on the spring brake control valve 264 connect the spring brake control valve 264 to the air supply line 262, the reservoir 266 and the first air delivery line 280. The air supply line 262 is connected to the air source 261 and a compressor system (not shown) which provide dried and filtered air to the air supply line 262, which in turn supplies same to the reservoir 166. The first air delivery line 280 extends from the spring brake control valve 264 to the first inlet 240 of the brake actuator 220. The second air delivery line 282 extends from the exhaust port 276 of the spring brake control valve 264 to the second inlet 260 of the brake actuator 220. The first and second air delivery lines 280, 282 may be secured to one another, if desired, as illustrated at 284.

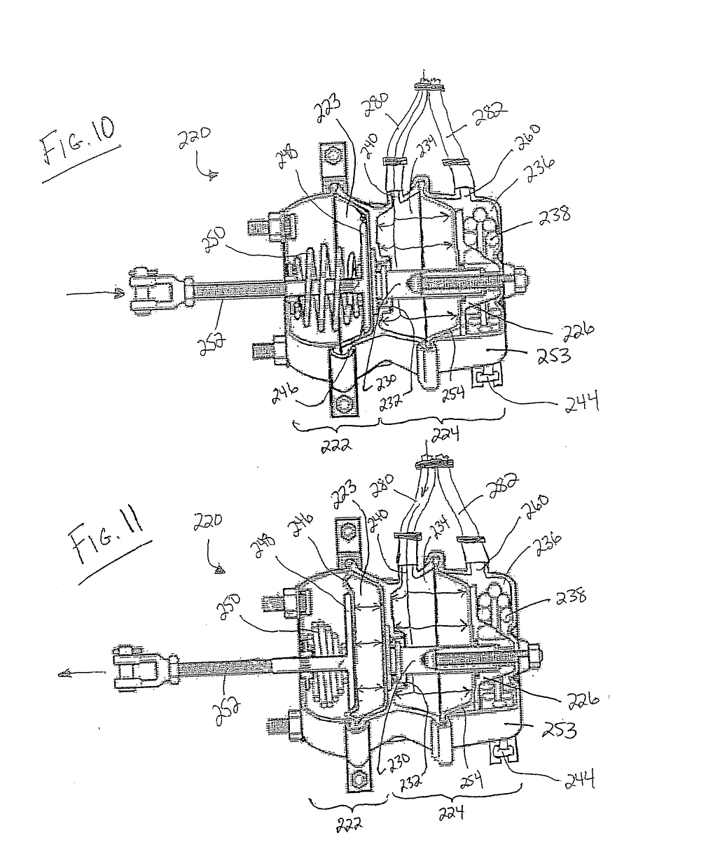

Operation of the brake actuator 220 and the brake assembly 221 will now be discussed with reference to FIGS. 9-12. FIG. 10 illustrates the spring brake actuator 220 in a fully released mode where neither the service brake or the parking brake is applied. When the parking brake is released, the pressurized air is directed to flow from the reservoir 166, through the first air delivery line 280 and into the pressure chamber 234 via the first inlet 240 and pushes on the diaphragm 254 and thus the piston 226 (as illustrated by the arrows in the first air delivery line 280, the inlet 240 and the pressure chamber 234). The piston 226 thus compresses the spring 238. There is no pressurized air in the service brake pressure chamber 223 (it should be noted that separate components of the brake assembly 221 supply air to the service brake pressure chamber 223 but these components are not described or illustrated as they are well-known in the art and are not germane to the present invention), and therefore, the piston 248 is positioned against the diaphragm 246 which, in turn, is positioned against the push rod 230 because of the spring force of the spring 250 in the service brake assembly 222. With the piston 248 in this retracted position, the braking arm 252 which extends therefrom is also retracted (as shown by the arrow directed to the right in FIG. 10) such that the brake is not applied.

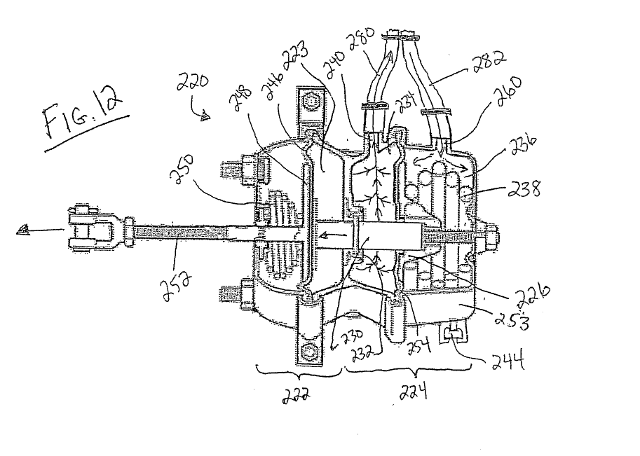

FIG. 11 illustrates the spring brake actuator 220 in a position where the service brake is applied, but the parking brake is not applied. In this mode, the parking brake spring 238 is out of the way and the push rod 230 is retracted, as shown and described with regard to FIG. 10, but pressurized air has been delivered to the service brake pressure chamber 223 between the diaphragm 246 and the end of the push rod 230 (as illustrated by the arrows in the service brake pressure chamber 223). The pressurized air pushes the diaphragm 246 and thus the piston 248 toward the service brake spring 250 to compress the service brake spring 250. Compression of the service brake spring 250 by movement of the piston 248 causes the braking arm 252 to be extended in order to apply the service brake (as shown by the arrow directed to the left in FIG. 11).

FIG. 12 illustrates the spring brake actuator 220 in a position where the parking brake is applied. In this mode, the air in the service brake pressure chamber 223 may have been exhausted by known means and the spring brake control valve 264 has stopped the supply of air to the first delivery line 280. The spring brake control valve 264 is configured at this stage to prevent the pressurized air from moving into the reservoir 266 or the air supply line 262. Rather, the spring brake control valve 264 is configured to allow the pressurized air to flow from the pressure chamber 234, into the first delivery line 280, through the spring brake control valve 264, into the second delivery line 282, via the exhaust port 276, and into the spring chamber 236 via the second inlet 260 (as shown by the arrows).

As a result of the pressurized air moving out of the pressure chamber 234, the spring 238 expands to move the piston 226, which in turn moves the push rod 230 (as shown by the arrow directed to the left on the push rod 230 in FIG. 12) to cause the end thereof to move into the service brake pressure chamber 223, against the diaphragm 246 and thus the piston 248. The piston 248 causes the spring 250 to compress and causes the braking arm 252 to extend, or to stay extended, if the service brake had previously been applied, in order to apply the parking brake (as shown by the arrow directed to the left in FIG. 12).

As a result of the pressurized air from the pressure chamber 234 being rerouted or redirected into the spring chamber 236 via the spring brake control valve 264, the pressurized air flows into the spring chamber 236 and an excess pressurized air exits the brake actuator 220 via the one-way check exhaust 244. The redirected pressurized air causes a purging action in the event contaminates get inside the spring chamber 236 from any means. As the pressurized air pressurizes the spring chamber 236, excess air is pushed out carrying with it any contamination via the one-way check exhaust 244. In addition, the pressurized air being rerouted or redirected from the pressure chamber 234 into the spring chamber 236 provides a pressure assist to cause the spring 238 to expand more rapidly.

Thus, in connection with the brake actuators 120, 220 and the braking assemblies 121, 221, atmospheric air is never allowed to enter the pressure chamber 134, 234 or the spring chamber 136, 236. Only clean, dried and filtered air from the air supply lines 162, 262 (which receives the air from a compressor system (not shown)) is allowed to enter the pressure chamber 134, 234 or the spring chamber 136, 236. Thus, no contaminants should be allowed into the housings 153, 253 which could cause corrosion to the parking brake spring 138, 238. If, however, during the manufacture and/or assembly of the brake actuators 120, 220 and/or the brake assemblies 121, 221, contaminants enter either the pressure chamber 134, 234 or the spring chamber 136, 236 defined within the housing 153, 253, the purging action should expel these contaminants from the brake actuators 120, 220 and the brake assemblies 121, 221.

Also, as the brake actuators 120, 220 and the brake assemblies 121, 221 are closed systems such that no atmospheric air is allowed to enter via the venting holes 56a, for example, the brake actuators 120, 220 and the brake assemblies 121, 221 are capable of proper function even when under water. The brake actuator 20a described and illustrated in FIGS. 2-4 could not function properly under water as water would be allowed to enter the brake actuator 20a through the vent holes 56a. In any case, even if water were somehow to enter the spring chamber 136, 236 of the brake actuators 120, 220, the water would be quickly expelled with the high volume of forced air being injected into the spring chamber 136, 236 and expelled out via the one-way check exhaust 144, 244.

It should be noted that the one-way check exhaust 144, 244 is illustrated in FIGS. 5-12 as being on the bottom of the spring chamber 136, 236, i.e., closer to ground level, however, it is not a necessity as it could be located most anywhere and still carry out contaminates with the high volume of air being forced into the spring chamber 136, 236. The bottom of the spring chamber 136, 236, however, is the preferred location of the one-way check exhaust 144, 244 as the one-way check exhaust 144, 244 will tend to also act as a sump at the same time.

Wile preferred embodiments of the invention are shown and described, it is envisioned that those skilled in the art may devise various modifications without departing from the spirit and scope of the foregoing description, the attached drawings and the appended claims.

The invention is claimed as follows:

1. A parking brake assembly used to apply an associated parking brake, said parking brake assembly comprising:
a housing having a pressure chamber and a spring chamber, said pressure chamber and said spring chamber being sealed off from one another within said housing, and a spring housed in said spring chamber;
means for providing pressurized air to said pressure chamber, said pressurized air within said pressure chamber preventing said parking brake assembly from applying the associated parking brake; and
means for redirecting said pressurized air within said pressure chamber to said spring chamber without breaking the seal between said pressure chamber and said spring chamber in order to allow said parking brake assembly to apply the associated parking brake, said redirecting means being external of said housing.

2. The parking brake assembly as defined in claim 1, wherein said providing means are provided external of said housing.

3. The parking brake assembly as defined in claim 1, wherein said housing has a diaphragm which divides said housing into said pressure chamber and said spring chamber, said diaphragm forming the seal between said pressure chamber and said spring chamber.

4. The parking brake assembly as defined in claim 3, wherein said diaphragm is formed of an elastomeric material.

5. A parking brake assembly as defined in claim 3, wherein said housing has a piston and a push-rod therein, said piston being provided in said spring chamber, said push-rod being connected to said piston and arranged to apply the associated parking brake when said piston is moved in a first direction caused by expansion of said spring within said spring chamber, said diaphragm being configured to act against said piston in order to move said piston in a second direction when said pressurized air is provided to said pressure chamber, whereby movement of said piston in said second direction causes said spring to compress within said spring chamber such that said push-rod cannot apply the associated parking brake, said diaphragm further being configured to move away from said piston in order to allow expansion of said spring within said spring chamber when said pressurized air is redirected to said spring chamber, whereby said piston is moved in said first direction such that said push-rod applies the associated parking brake.

6. The parking brake assembly as defined in claim 1, wherein said providing means includes an air source, a control valve and a release valve, said air source being connected to said control valve, said control valve being connected to said release valve, said release valve being connected to said pressure chamber such that air can flow from said air source, through said control valve, through said release valve, and into said pressure chamber.

7. The parking brake assembly as defined in claim 6, said release valve being connected to said spring chamber such that said pressurized air within said pressure chamber flows out of said pressure chamber, into and through said release valve, and into said spring chamber.

8. The parking brake assembly as defined in claim 1, wherein said providing means includes an air source and a control valve having an exhaust port, said air source being connected to said control valve, said control valve being connected to said pressure chamber such that air can flow from said air source, through said control valve, and into said pressure chamber.

9. The parking brake assembly as defined in claim 8, said exhaust port of said control valve being connected to said spring chamber such that said pressurized air within said pressure chamber flows out of said pressure chamber, into said control valve and out of said exhaust port of said control valve, and into said spring chamber.

10. The parking brake assembly as defined in claim 1, wherein said housing has an exhaust which is in communication with said spring chamber, wherein at least a portion of said redirected pressurized air within said spring chamber is forced out of said spring chamber through said exhaust.

11. The parking brake assembly as defined in claim 10, wherein said exhaust is a one-way check valve such that atmospheric air cannot enter said spring chamber through said exhaust.

12. The parking brake assembly as defined in claim 10, wherein said exhaust is in communication with a bottom of said spring chamber.

13. The parking brake assembly as defined in claim 1, further including a piston connected to a push-rod, said piston being provided within said spring chamber such that upon said spring being compressed within said spring chamber when said pressurized air is within said pressure chamber, said push-rod is not arranged to apply the associated parking brake, and such that upon said spring being expanded within said spring chamber when said pressurized air is redirected to said spring chamber, said push-rod is arranged to apply the associated parking brake.

14. The parking brake assembly as defined in claim 1 provided in tandem on a back end of a service brake assembly.

15. A parking brake assembly used to apply an associated parking brake, said parking brake assembly comprising:
an air source;
a housing having a pressure chamber and a spring chamber therein which are sealed off from one another within said housing, and a spring housed in said spring chamber; and
a valve assembly which is external of said housing and which interconnects said air source, said pressure chamber and said spring chamber, said valve assembly being configured to receive pressurized air from said air source and direct same into said pressure chamber in order to prevent said parking brake assembly from applying the associated parking brake, said valve assembly further being configured to redirect said pressurized air within said pressure chamber to said spring chamber without breaking the seal between said pressure chamber and said spring chamber within said housing in order to allow said parking brake assembly to apply the associated parking brake.

16. The parking brake assembly as defined in claim 15, wherein said housing has a diaphragm therein which divides said housing into said pressure chamber and said spring chamber, said diaphragm forming the seal between said pressure chamber and said spring chamber.

17. The parking brake assembly as defined in claim 16, wherein said diaphragm is formed of an elastomeric material.

18. A parking brake assembly as defined in claim 16, wherein said housing has a piston and a push-rod, said piston being provided in said spring chamber, said push-rod being connected to said piston and arranged to apply the associated parking brake when said piston is moved in a first direction caused by expansion of said spring within said spring chamber, said diaphragm being configured to act against said piston in order to move said piston in a second direction when said pressurized air is within said pressure chamber, whereby movement of said piston in said second direction causes said spring to compress within said spring chamber such that said push-rod cannot apply the associated parking brake, said diaphragm further being configured to move away from said piston in order to allow expansion of said spring within said spring chamber when said pressurized air is redirected to said spring chamber, whereby said piston is moved in said first direction such that said push-rod applies the associated parking brake.

19. The parking brake assembly as defined in claim 15, wherein said valve assembly includes a control valve and a release valve, said air source being connected to said control valve, said control valve being connected to said release valve, said release valve being separately connected to said pressure chamber and to said spring chamber such when said parking brake assembly is to be prevented from applying the associated parking brake, pressurized air can flow from said air source, through said control valve, through said release valve, and into said pressure chamber, and such that when said parking brake assembly is allowed to apply the associated parking brake, said pressurized air within said pressure chamber can flow through said release valve, and into said spring chamber.

20. The parking brake assembly as defined in claim 15, wherein said valve assembly includes a control valve having an exhaust port, said air source being connected to said control valve, said control valve being connected to said pressure chamber and separately connected to said spring chamber via said exhaust port such that when said parking brake assembly is to be prevented from applying the associated parking brake, pressurized air can flow from said air source, through said control valve, and into said pressure chamber, and such that when said parking brake assembly is allowed to apply the associated parking brake, said pressurized air within said pressure chamber can flow into said control valve and out said exhaust port, and into said spring chamber.

21. The parking brake assembly as defined in claim 15, wherein said housing has an exhaust which is in communication with said spring chamber, wherein at least a portion of said redirected pressurized air within said spring chamber is forced out of said spring chamber through said exhaust.

22. The parking brake assembly as defined in claim 21, wherein said exhaust is a one-way check valve such that atmospheric air cannot enter said spring chamber through said exhaust.

23. The parking brake assembly as defined in claim 21, wherein said exhaust is in communication with a bottom of said spring chamber.

24. The parking brake assembly as defined in claim 15, further including a piston connected to a push-rod, said piston being provided within said spring chamber such that upon said spring being compressed within said spring chamber when said pressurized air is within said pressure chamber, said push-rod is not arranged to apply the associated parking brake, and such that upon said spring being expanded within said spring chamber when said pressurized air is redirected to said spring chamber, said push-rod is arranged to apply the associated parking brake.

25. The parking brake assembly as defined in claim 15 provided in tandem on a back end of a service brake assembly.

26. A method of operating a parking brake, said method comprising the steps of:
a) providing a parking brake assembly having a housing defining a pressure chamber and a spring chamber which are sealed off from one another within said housing;
b) when the parking brake is not applied, providing pressurized air to said pressure chamber, said pressurized air within said pressure chamber preventing the parking brake from being applied; and
c) when the parking brake is to be applied, exhausting said pressurized air out of said pressure chamber and out of said housing and redirecting said pressurized air back into said housing to said spring chamber without breaking the seal between said pressure chamber and said spring chamber, said exhausting and redirecting of said pressurized air allowing the parking brake to be applied.

27. The method as defined in claim 26, further comprising the step of:
d) providing a valve assembly which is exterior of said housing, said valve assembly configured to interconnect said pressure chamber and said spring chamber such that said pressurized air which is exhausted out of said pressure chamber and out of said housing is exhausted into said valve assembly and is redirected into said housing to said spring chamber via said valve assembly.

28. The method as defined in claim 26, further comprising the steps of:
d) providing a one-way check valve in said spring chamber; and
e) forcing at least a portion of said redirected pressurized air in said spring chamber out of said spring chamber through said one-way check valve.

29. The method as defined in claim 26, further comprising the step of:
d) providing a diaphragm within said housing which provides the seal between said pressure chamber and said spring chamber.

30. The method as defined in claim 29, further comprising the steps of:
e) providing a piston, a push-rod and a spring within said housing, said piston and said spring being provided in said spring chamber; and
f) causing said diaphragm to act against said piston in order to move said piston which causes said spring to compress within said spring chamber such that said push-rod cannot apply the parking brake, when said pressurized air is within said pressure chamber.

31. The method as defined in claim 29, further comprising the steps of:
e) providing a piston, a push-rod and a spring within said housing, said piston and said spring being provided in said spring chamber; and
f) causing said diaphragm to move away from said piston in order to allow expansion of said spring within said spring chamber such that said push-rod applies the parking brake, when said pressurized air is redirected to said spring chamber.

32. The method as defined in claim 26, further comprising the steps of:
d) providing a piston, a push-rod and a spring within said housing, said piston and said spring being provided in said spring chamber, said piston being connected to said push-rod; and
e) compressing said spring within said spring chamber when said pressurized air is within said pressure chamber such that said push-rod cannot apply the parking brake.

33. The method as defined in claim 26, further comprising the steps of:
d) providing a piston, a push-rod and a spring within said housing, said piston and said spring being provided in said spring chamber, said piston being connected to said push-rod; and
e) expanding said spring within said spring chamber when said pressurized air is redirected to said spring chamber such that said push-rod can apply the parking brake.
